(19) United States
(12) Patent Application Publication
(10) Pub. No.: US 2003/0211936 A1
(43) Pub. Date: Nov. 13, 2003

(54) NOx storage catalyst and production and use thereof

(75) Inventors: Michael Bender, Ludwigshafen (DE); Michael Hesse, Worms (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/464,668

(22) Filed: Jun. 19, 2003

Related U.S. Application Data
(63) Continuation of application No. 10/015,632, filed on Dec. 17, 2001, now abandoned.

(30) Foreign Application Priority Data
Dec. 19, 2000 (DE) 10063220.3

(51) Int. Cl. B01J 27/053; B01J 27/045; B01J 8/02; C01B 21/00

(52) U.S. Cl. 502/217; 502/223; 423/213.2

(57) ABSTRACT

Disclosed is an NOₓ storage catalyst in honeycomb form wherein the honeycomb is formed from at least one alkaline earth metal sulfate as precursor compound of the storage material, optionally in combination with the customary concomitant and assistant materials and/or optionally at least one stabilizer.

Also disclosed is a process for producing such a catalyst. The catalyst is useful for detoxifying exhaust gases from lean burn engines.

The present invention relates to an NOₓ storage catalyst used for removing NOₓ compounds from lean exhaust gases. The catalyst has a honeycomb structure and contains an alkaline earth metal sulfate as a precursor substance of the storage material, the sulfate being incorporated in the honeycomb structure itself or serving as a material therefor.

NOₓ storage catalysts are known per se and are used for the exhaust gas cleanup of lean burn engines (gasoline engines and diesel engines). Such engines are operated using an air-fuel mix having an oxygen content substantially above that needed for the complete combustion of the fuel. This leads to an oxygen excess in the exhaust gas from these engines. The known three-way catalysts require a stoichiometrically composed exhaust gas for the concurrent conversion of the hydrocarbons, carbon monoxide and nitrogen oxides (NOₓ) present in the exhaust gas and are therefore not suitable for detoxifying the exhaust gases from lean burn engines.

Carbon monoxide and hydrocarbons, unlike nitrogen oxides, are easily removable from the exhaust gases by means of the customary exhaust gas catalysts, by oxidation. Nitrogen oxides are removed using the NOₓ storage catalysts mentioned. These contain metal salts which react with the nitrogen oxides to form nitrates or else just physically absorb the nitrogen oxides. Examples of nitrogen oxides are NO, NO₂, NO₃, N₂O₃, N₂O₄ and N₂O₅, exhaust gases from internal combustion engines mainly containing NO. However, NO is oxidized to NO₂ for reaction with the storage compounds. To provide for NO oxidation in the lean mode and store regeneration in the rich mode, the storage catalysts customarily contain redox-active dopings of metals, preferably platinum metals.

The storage material has to be regenerated after a certain length of run, since the coating with nitrogen oxides or the reaction therewith has exhausted the capacity of the material. To this end, the air-fuel mix is enriched, i.e., the air content is lowered relative to the amount of fuel. This also lowers the oxygen content in the exhaust gas, and the nitrates formed are initially decomposed back into nitrogen oxides which are then reduced to elemental nitrogen by the reducing atmosphere prevailing in the exhaust gas.

The catalysts are generally present in the form of honeycomb structures which possess a number of essentially parallel channels through which the gas to be treated flows. In cross-sectional view, such honeycomb structures may correspond to honeybee combs, for example. The individual channels may also have a round or rectangular, especially square, cross section, so that the cross section through the honeycomb structure corresponds to a right-angled grid pattern.

Prior art NOₓ storage catalysts are provided by applying a layer of the storage material, frequently in finely divided form, to the honeycomb structure of carrier material. This frequently gives rise to the problem, especially at high temperatures, that the storage compound reacts with the carrier material, resulting in an activity drop. To circumvent this problem, various solutions are proposed in the literature; see the references cited in EP-A 993 860 by way of example.

EP-A 993 860 also discloses an NOₓ storage catalyst containing as the storage material not the otherwise customary oxides and acetates of alkaline earth metals, but the sulfates of these metals, especially of strontium or barium, as a precursor compound of the active storage material. These sulfates have to be additionally activated after application to the carrier material. For this, they are brought into contact with a stoichiometric or rich exhaust gas at >550° C., and the active compound is formed through release of SO₂. This makes it possible to incorporate a large amount of storage components in the catalyst.

These sulfates are applied to the carrier in a conventional manner by first preparing a dispersion which contains the sulfate as well as optionally the customary assistants and binders. The honeycomb structure is then coated with the storage material or its precursor compound by immersion in the dispersion, drying and calcining. The precursor compound of the storage component can be desulfated at least partially even at this stage by employing a reducing atmosphere, advantageously containing a mixture of H₂ and CO, at high temperatures; but this desulfation can also be carried out later, before the use as exhaust gas catalyst.

Although the above-described NOₓ storage catalyst has sufficient storage capacity for some applications, this storage capacity remains in need of improvement nonetheless. Moreover, because the precursor compound of the storage material is applied in the form of a thin film, the mechanical strength and the consistency of operation frequently fall short of what is desired. In addition, prior art fabrication is very inconvenient.

It is an object of the present invention to provide an NOₓ storage catalyst which compared with prior art storage catalysts has a high storage capacity and also high strength and abrasion resistance and is simple to produce.

We have found that this object is achieved by an NOₓ storage catalyst in honeycomb form wherein the honeycomb is formed from at least one alkaline earth metal sulfate as precursor compound of the storage material, optionally in combination with the customary concomitant and assistant materials and/or optionally at least one stabilizer.

The catalyst of the invention customarily further contains an active component, customarily a transition metal, preferably a metal from the group consisting of palladium, platinum, rhodium, iridium and ruthenium. In the activated form, at least a portion of the sulfates serving as a precursor compound have been converted into an active storage material, generally the corresponding oxide, carbonate or nitrate/nitrite.

In contrast to the NOₓ storage catalysts of EP-A 993 860, the precursor compound of the storage material is not applied to the honeycomb structure, but the honeycomb structure is at least partly constructed from the precursor compound of the storage material or, in the activated form, the storage material itself. To obtain sufficient strength, it is preferable to admix the precursor compound of the storage material with a stabilizer before introduction into a honeycomb structure to ensure sufficient stability. This stability is in most cases of the storage material precursor compounds customarily used not obtainable without a stabilizer. Useful stabilizers include inorganic systems such as aluminum oxides and hydroxides, silicon dioxide, zirconium oxide, titanium dioxide, titanic acids, steatite, cordierite, clays and sheet-silicates.

Further assistants which may be optionally present in the carrier material are for example assistants which improve the extrudability of the composition and/or pore-formers. The addition of pore-formers is preferred, since this will reopen the pores closed by the compacting process taking place during the extrusion to form a honeycomb structure. As a result, the inner surface of the honeycomb wall becomes accessible to the exhaust gas components by diffusion.

Examples of extrudability improvers are additives which have a rheology-modifying effect on the extrusion compound. They can be organic additives, for example carboxymethylcelluloses, hydroxymethylcelluloses, starch, alginates, polyethylene oxides, polyvinyl alcohols of differing molar mass and other polymers known to one skilled in the art. It is also possible to use inorganic extrudability improvers, for example clays and sheet-silicates.

The aforementioned organic additives naturally also have a pore-forming effect in a subsequent heat treatment of the formed structure. Useful pore-formers further include for example carbohydrates such as sugars or sorbitols, meals, graphite, carbon black, carbon fibers and also liquid removable organics.

The precursor compounds of the NOₓ storage materials which are used to produce the honeycomb structure according to the present invention correspond to the precursor compounds known per se. These are the sulfates of alkaline earth metals, the use of strontium sulfate and barium sulfate being preferred. Barium sulfate is used in particular.

To produce the honeycomb structure, the precursor compound of the storage material is mixed with the optionally present stabilizers and/or assistants and brought into a homogeneous form, preferably by kneading. The honeycomb structure is then produced from this composition by extrusion in a conventional manner, for example as disclosed in EP-A 945 177 (applicant: BASF AG).

Following extrusion, the green honeycomb structure obtained is dried and calcined. After calcination, the active component, i.e., the catalyst species used, is applied to the honeycomb structure. Useful catalyst species include the customary, well-known transition metals, especially palladium, platinum, rhodium, iridium and/or ruthenium. However, it is also possible to apply other transition metals, for example Cu, Ni, Fe, etc., using methods known to one skilled in the art. For example, the honeycomb structure can be repeatedly dipped into the salt solution in question and dried between the individual dipping operations. It is also possible to apply a sol of the active component or components, in which case the preferably stabilized sol can be applied by dipping, spraying, brushing or sponging.

The catalyst honeycomb structure thus obtained has to be activated to develop the NOₓ storage capacity. This activation can take place before or after installation in a motor vehicle, activation before installation being preferred. Activation is effected by contacting the catalyst with an oxygen-free gas which preferably contains hydrocarbons, hydrogen, carbon monoxide or a mixture of at least two of these components. The activating step is carried out at >400° C., preferably >470° C., especially >550° C. Activation converts the sulfate or sulfates present as a precursor compound into a storage-active form by releasing sulfur dioxide.

Alternatively, it is also possible to install the honeycomb with the unactivated precursor compound of the active storage spaces in a motor vehicle and effect activation by contact with the exhaust gases from the engine. For this, the engine has to be operated in an operating parameter window in which the exhaust gas contains the appropriate components necessary for activation.

An NOₓ storage catalyst according to the invention has a lot of advantages over previously known storage catalysts. Owing to the large amount of storage-active compounds in the honeycomb wall, the NOₓ storage capacity is higher than that of the previously known catalysts. Catalysts according to the invention are simpler and particularly in fewer steps to produce than previously known catalysts, and their consistency and lifetime are improved because of the improved mechanical strength. The reduced attrition, moreover, reduces environmental emissions. More particularly, the catalyst of the present invention is also simpler to produce than previously known catalysts because, owing to the larger storage material quantity, the storage material particles no longer have to be present in the extremely finely divided form of <1 μm in the production process.

The storage catalysts of the invention are useful for detoxifying the exhaust gases from diesel engines and gasoline lean burn engines.

The examples hereinbelow illustrate the invention.

### EXAMPLE 1

### Manufacture of a Barium Sulfate Containing Fully Extruded Honeycomb

A catalyst according to the invention is produced by mixing and kneading 827 g of pseudoboehmite (AIOOH) with 9000 g of BaSO₄. This mixture is admixed with 104 g of hydroxymethylcellulose, 104 g of polyethylene oxide (molecular weight about 2000) and also 400 g of formic acid (50% aqueous solution) and 1000 g of water. The mixture is then kneaded for 4 h. The dough thus produced is then extruded into honeycomb structures about 50×50 mm in cross section using outer die rings having 6×6, 13×13, 40×40 and 60×60 cells across the abovementioned cross section.

The honeycomb structures are cut, wrapped in film and air dried. After a weight reduction of 8% being achieved in this way, the drying was continued without film in a through circulation drying cabinet at a slowly increasing temperature (30-60° C.). The honeycomb structures were then heat treated at 500° C. for 2 h.

The finished honeycombs have a BET surface area of 30 m2/g and a porosity (determined by Hg porosimetry of 0.112 ml/g. They are 90% by weight BaSO₄.

The finished honeycombs are subsequently doped with platinum by sol impregnation or by dipping with a platinum salt solution. The two honeycomb structures are subsequently heat treated at 650° C. in an H₂ stream for 1 h.

### EXAMPLE 2

### Preparation of a Monolithic Extrudate Comb Containing Barium Sulfate

A comb structure containing barium sulfate is prepared by mixing 6000 g of BaSO₄, 3612 g of cordierite and 1414 g of AIOOH, each in powder form. The mixed powders are admixed with water, formic acid and customary rheological additives such as cellulose derivatives, waxes or alkoxides to prepare an extrudable dough by kneading. The kneading time is about 1 hour. The dough thus produced is extruded into comb structures of the desired cellularity, which are dried and heat treated at 800° C. for 2 hours.

The comb structures thus produced have a BET surface area of 24 m²/g and a porosity (determined by Hg porosimetry) of 0.14 ml/g.

### EXAMPLE 3

### Preparation of a Thin Film Storage Catalyst

The comb structure produced in example 2 has to be loaded with noble metal to be useful as a storage catalyst. This is accomplished by impregnating with colloidal noble metal from aqueous solution. The comb structure was sawn into a suitable piece having a square end face 25×25 mm in size and a length of 110 mm (weight=88 g). This piece was impregnated with an ethanolic/aqueous platinum sol. The 3% platinum sol was prepared by a procedure described in EP-A 0 920 912. 200 ml of the sol were introduced into a 500 ml graduated cylinder and the support was placed into it in an axially upright position, so that all the channels of the comb structure were wetted. After a residence time of 1 hour the comb structure was removed from the sol, allowed to drip off and dabbed off with absorbent cotton. The capillary uptake of liquid (12.2 ml) was used to calculate a platinum coating on the support of 0.042% of Pt.

The catalyst precursor obtained in this way was dried at 120° C. for 2 hours. The reductive activation by reaction of the barium sulfate with hydrogen was effected by calcination in an H₂ gas stream (about 10 l/h) for 2 hours at 600° C. in an oven. This calcination produces H₂S as per the scheme:

BaSO₄+4H₂→Ba(OH)₂+H₂S+2H₂O+BaO+H₂S+3H₂O

This converts some of the barium sulfate into the partly oxidic, partly hydroxidic storage form.

### EXAMPLE 4

### Preparation of a Monolithic Storage Catalyst

Here the noble metal phase is introduced by impregnating the comb structure prepared under 1 with a platinum salt solution. For this purpose, a further specimen of the barium sulfate comb structure was prepared as described in example 3. The water absorption capacity of this comb structure was found to be 11.4 g by saturating in water for an hour, dripping off and dabbing with absorbent cotton. The platinum salt concentration for the subsequent platinum salt impregnation was calculated so that in total a platinum content of 10 mmol/l was obtainable for the catalyst. 50 g of aqueous H₂PtCl₆ solution having a 5% Pt content were made up with distilled water to 207 g. The solution was introduced into a graduated cylinder and the support was placed in it and left to reside therein for 1 hour. During this period, the support absorbed 11.6 g of Pt salt solution (0.2 g more than theoretically predicted). The coating obtained thereby was 0.162% of Pt, which corresponds to a Pt concentration of 10.41 mmol/l (support). This piece was likewise reduced with hydrogen in the manner described in example 3.

We claim:

1. An NOₓ storage catalyst in honeycomb form wherein the honeycomb is formed from at least one alkaline earth metal sulfate as precursor compound of the storage material, optionally in combination with the customary concomitant and assistant materials and/or optionally at least one stabilizer.

2. The catalyst of claim 1 wherein the sulfate is strontium sulfate and/or barium sulfate, preferably barium sulfate.

3. The catalyst of claim 1 further containing an active component from a transition metal.

4. The catalyst of claim 3, wherein the active transition metal component is selected from the group consisting of platinum, rhodium, iridium and ruthenium.

5. The catalyst of claim 1, wherein the precursor compound has been partially or completely converted into the active storage material.

6. The catalyst according to claim 5, wherein the active storage material is selected from oxides, carbonates, nitrates and nitrites.

7. The catalyst of claim 1, wherein the stabilizer is selected from the group consisting of aluminum oxides and hydroxides, silicon dioxide, zirconium oxide, titanium dioxide, titanic acids, steatite, cordierite, clays and sheet-silicates.

8. A process for producing a catalyst as claimed in claim 1, which comprises the precursor compound of the storage material and the optionally present assistant and concomitant materials and/or the stabilizer being brought into a homogeneous form and the composition thus obtained being extruded to form a honeycomb structure to which the active component is optionally applied, and the precursor compound being optionally converted into the active storage material by activating.

9. The process of claim 8, wherein the materials are brought into a homogneous form by kneading.

10. The process of claim 8 wherein an organic or inorganic extrudability improver is added.

11. The process of claim 10, wherein the extrudability improver is selected from the group consisting of carboxymethylcelluloses, hydroxymethylcelluloses, starch, alginates, polyethylene oxides and polyvinyl alcohols of differing molar mass, clays and sheet-silicates.

12. The process of claim 8, wherein a pore-former is added.

13. The process of claim 12, wherein the pore-former is selected from the group consisting of carboxymethylcelluloses, hydroxymethylcelluloses, starch, alginates, polyethylene oxides and polyvinyl alcohols of differing molar mass, clays and sheet-silicates and carbohydrates.

14. The process of claim 13, wherein the pore-former is selected from sugars and sorbitols, meals, graphite, carbon black, carbon fibers and liquid removable organics.

15. The process of claim 8, wherein the active component is applied by immersion in a salt solution of the corresponding metal or by applying a sol of the active component.

16. The process of claim 15, wherein the active component is applied by dipping, spraying, brushing or sponging.

17. The process of claim 8, wherein the activating is effected by contacting with an oxygen-free gas which preferably contains hydrocarbons, hydrogen, carbon monoxide or a mixture of at least 2 of these components at >400° C., before or after installation of the catalyst in a motor vehicle.

18. The process of claim 17, wherein the activating is effected at >470° C.

19. The process of claim 18, wherein the activating is effected at >550° C.

20. Use of an exhaust gas catalyst as claimed in claim 1 for detoxifying the exhaust gases from diesel engines or lean burn gasoline engines.
